(19) United States
(12) Patent Application Publication
(10) Pub. No.: US 2004/0215618 A1
(43) Pub. Date: Oct. 28, 2004

(54) Automated quality compliance system

(76) Inventors: Robert S. Wacke, Toledo, OH (US); Karen M. Kerr, Cygnet, OH (US)

Correspondence Address: OWENS-ILLINOIS, INC., ONE SEAGATE, 25-LDP, TOLEDO, OH, 43666, US

(21) Appl. No.: 10/424,209

(22) Filed: Apr. 25, 2003

(51) Int. Cl. G06F 17/30

(52) U.S. Cl. 707/10

(57) ABSTRACT

A process for systematizing, monitoring and auditing a project for production of a product or service includes providing a project description as an interconnection of stages to produce the product or service, and providing custom databases for storage of and access to documents associated with each stage of the description. At each stage of production of the product or service, documents are entered into the appropriate database so that, during or upon completion of the project, performance at each stage of the project description can be audited by access to the documents in the database or databases associated with that stage. In the preferred embodiment of the invention, a quality control auditor is provided with access to the databases for auditing documents associated with selected stages or each stage of the project.

The present disclosure is directed to a process for systematizing, monitoring and auditing a project for production of a product or service.

### BACKGROUND AND SUMMARY OF THE INVENTION

Quality management auditing, for compliance with ANSI/ISO9001-2000 for example, requires that an auditor be provided with ready access to all documents associated with proposal, approval, design and implementation of production of a product or service. Creation and storage of individual paper documents can be an impediment both to project management and to quality auditing. It is therefore a general object of the present invention to provide a process for systematizing, monitoring and auditing a project for production of a product or service that simplifies record keeping, identifies the current status of project stages, provides an intuitive framework for maintaining process history, and incorporates requirements for quality management and auditing in accordance with ISO09001-2000, for example.

A process for systematizing, monitoring and auditing a project for production of a product or service in accordance with the present invention includes providing a project description as an interconnection of stages to produce the product or service, and providing custom databases for storage of and access to documents associated with each stage of the description. At each stage of production of the product or service, documents are entered into the appropriate database so that, during or upon completion of the project, performance at each stage of the project description can be audited by access to the documents in the database or databases associated with that stage. In the preferred embodiment of the invention, a quality control auditor is provided with access to the databases for auditing documents associated with selected stages or each stage of the project.

### BRIEF DESCRIPTION OF THE DRAWINGS

The invention, together with additional objects, features, advantages and aspects thereof, will be best understood from the following description, the appended claims and the accompanying drawings, in which:

FIG. 1 is a combined flowchart and functional block diagram of a system in accordance with a presently preferred embodiment of the invention; and

FIG. 2 is a more detailed flowchart illustrating a specific implementation of the system of FIG. 1.

### DETAILED DESCRIPTION OF PREFERRED EMBODIMENTS

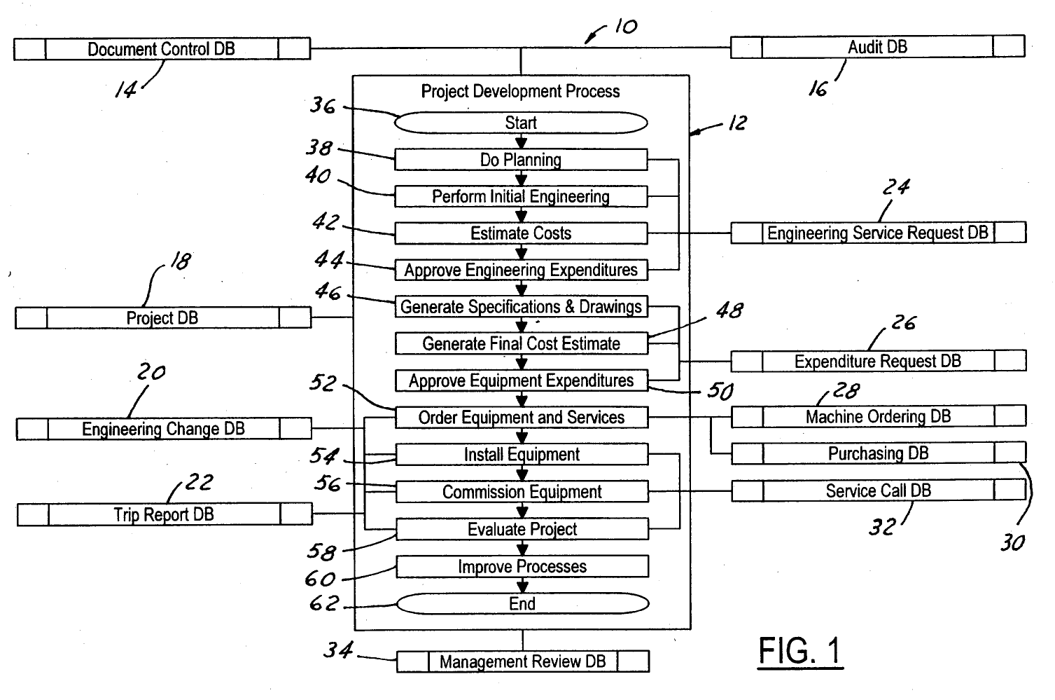

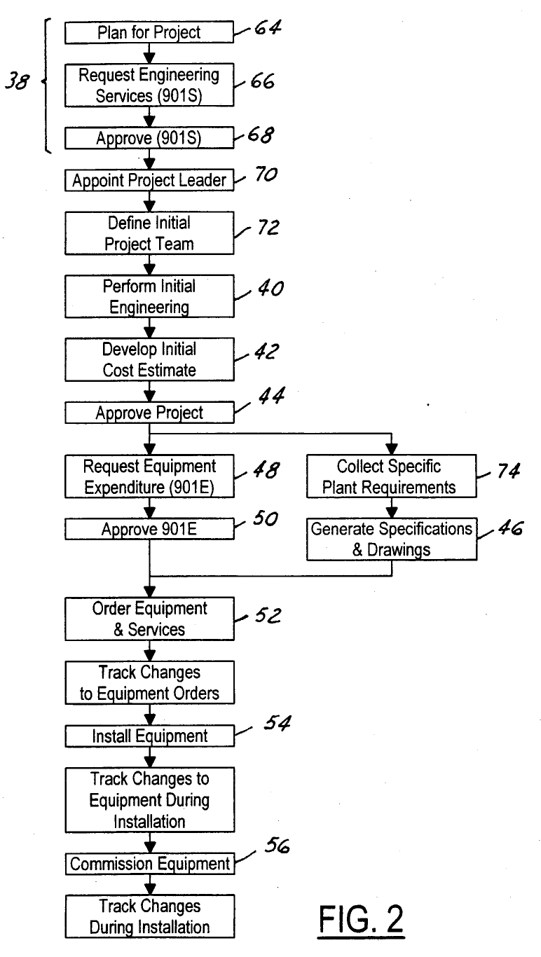

FIG. 1 is combined a flowchart and functional block diagram of a project development process in accordance with a presently preferred embodiment of the invention. The overall flow of process 10 involves an interconnection of a number of sequential or parallel stages to produce a product or service. Process 10 may be designed using premade templates or the like that are specially configured for a specific project. The overall project illustrated in FIG. 1 and the detailed flow chart of FIG. 2 are specific examples prepared for use by applicants' assignee for manufacture, refurbishment or repair of equipment for producing glass containers. In specific implementations, or in implementations for other products or services, one or more of the stages illustrated in FIGS. 1 and 2 may be modified or deleted, or additional stages added as desired.

The overall process 10 illustrated in FIG. 1 involves an interconnected description 12 of various stages to produce a product or service, and a number of custom databases 14-34 for storage of and access to documents associated with one or more stages of project description 12. Project description 12 includes an initiation stage 36 followed by a stage 38 for conducting initial planning and a stage 40 for performing initial engineering. Costs are initially estimated at 42 and submitted for approval at 44. Following initial approval, specifications and drawings are generated at 46, and final cost estimates are generated at 48. Equipment expenditures are then approved at 50 by the appropriate management personnel. Following equipment expenditure approval, equipment is ordered at 52, installed at 54 and commissioned or placed in operation at 56. Following installation of the equipment (or completion of the service when the project involves services rather than equipment), the overall project is evaluated at 58, and recommendations are made at 60 to improve the process. The project is then considered to be completed or terminated at 62.

The databases include a document control database 14, an audit database 16, an overall project database 18 and a management review database 34 that are shown as being connected to the overall description 12 in FIG. 1, which is to say that the documents and information stored in these databases are associated with the overall project rather than with specific stages in the project. An engineering service request database 24 stores documents associated with engineering stages 38-44. An expenditure request database 26 stores documents associated with process stages 48 and 50. An engineering change database 20 and a trip report database 22 store documents associated with process stages 52-58. A machine ordering database 28 and a purchasing database 30 store documents associated with equipment or service ordering stage 52, and a service call database 32 stores documents associated with installation and commissioning of equipment stages 54, 56 and product evaluation stage 58.

Project database 18 stores all project-related documents, either in its original form such as word-processing files, e-mail text or spreadsheets, or as a link to related documents in other databases or storage dictionaries. Data in this database is organized by project number and title. Key documents, such as initial project request and approval documents, may be listed in project database 18 with links to other databases. All of the other databases are also linked from and to project database 18.

Document control database 14 includes any quality-related documents that must be controlled for currency of content, legibility, security and control of access. Examples are quality system procedures and manuals, and forms for use in entering documents to other databases. These forms may include, for example, engineering service request forms, engineering change forms, trip report forms, expenditure request forms, machine ordering forms, purchase request forms and service call report forms. Each form is pre-structured so that it may be accessed and completed by an appropriate user, and then automatically stored upon completion in the appropriate database. For example, the form for requesting a purchase of equipment or services may be completed by a requester, including entry of the appropriate project code, whereupon the purchase request form will automatically be stored in purchasing database 30 under the appropriate project number upon completion and entry of the form. The premade forms automatically cross-link the document, upon entry into the appropriate database, to other databases specified in the forms. Forms can also be designated to be sent to specified persons, such as the project leader, upon completion and entry. Each form may also specify the persons who can make changes in the document once the document has been entered into the appropriate database. Documents that are not prepared on standard forms may be entered as a word processing document, for example, or scanned and entered manually into the appropriate database. A built-in text search capability in the databases aids in locating references to specific subjects rapidly. Documents are stored in all databases by project number and in order, such as reverse chronological order.

Projects are initiated with a statement of scope and an approval of spending on engineering for an initial estimate of the total project cost. The documents that capture this information are stored in engineering service request database 24. Once the cost of a project has been estimated and approved by management, the estimate and approval documents are stored in expenditure request database 26. This database provides a work flow engine with automatic reminders to obtain approvals for initial refined or revised costs.

Upon approval of a project, purchase requests and orders are generated and stored in purchasing database 30. Machine ordering database 28 in FIG. 1 is a database associated with custom-built individual-section glass container forming machines, which are built by a separate division of applicants' assignee and not by outside vendors. For this reason, machine ordering database 28 preferably is maintained separate from purchasing database 30. Machine ordering database 28 includes a complete specification of the customer requirements for an individual section machine, including mechanical and electrical questionnaires that define the machine configuration. Machine ordering database 28 provides a single point of origin for questionnaires, specifications, meeting minutes, quotations, correspondence, revision history and other documentation pertinent to the definition and ordering of the individual-section machine.

Engineering change database 20 captures corrections, improvements and changes implemented in the equipment, whether at the request of the customer or otherwise. The engineering change database thus provides a means to document and store change orders, involved personnel, and correspondence between engineering departments and vendors as changes are proposed, tested and implemented. Service call database 32 is used to record service requests by customers to technical personnel, and corresponding solutions implemented to resolve the service requests. The database preferably contains information that provides ready identification of a request, the names of involved personnel, the nature of the request, the actions taken, the results and any follow-up that is required. The service call database typically is involved in a major project for evaluating problems that occur after the installation and start-up phases are complete. Information in this database may be explored as a new major project begins to evaluate the need for corrective or preventive actions.

New equipment installation, new equipment start-up, and field service of existing equipment are the major reasons for technical personnel to visit customer facilities. To derive maximum benefit from plant visits by technicians and engineers, their findings and recommendations are distributed to the appropriate manufacturing and technical management personnel. Trip report database 22 provides a repository for trip reports, as well as for documentation on follow-up action items and an automatic reminder to concerned personnel that an action is past due.

Internal audits are an important part of any quality system. Keeping a central record of audit personnel, audit schedules, audit findings and corrective action reports allows the quality system manager and the engineering department managers to be informed of quality system status and rapidly to access documentation pertinent to quality system audits of selected areas of the business. Audit database 16 provides a structure to store audit data and manage required follow-ups with automatic reminders of actions required to comply with quality system non-conformities. Audit database 16 may additionally provide storage for management review meeting schedules, agenda and meeting minutes. Management review database 34 is used for storing various management control and review documents not placed in other databases.

FIG. 2 is a more detailed flowchart of project development process description 12 in FIG. 1 for design, purchase and installation of capital equipment. The flowchart of FIG. 2 will be discussed in connection with installation of a new glass furnace by way of example. Reference numerals employed in FIG. 2 that are identical to numerals in FIG. 1 provide for cross-reference between these figures.

After it is decided to investigate the possibility of installing a new glass furnace at a specific plant, initial project planning takes place at 64, which includes working with the customer to provide the project description 12 illustrated in FIG. 1. An appropriate person, such as a plant manager, prepares a request for engineering services at 66, which is referred to as a 901S form in this example. The requesting person may obtain a 901S form from engineering service request database 24 (FIG. 1), and complete the form with appropriate dates and work scope. Upon completion of this form, the form is automatically entered into the engineering service request database 24 (FIG. 1), and automatically transmitted to the first member of an approval list. The approval list is prestored in database 24 according to project type and plant of origin. Each succeeding approver, starting with the first approver, is automatically notified by e-mail when the preceding approval occur. The e-mail contains an icon link to the 901S document approval form that is automatically generated by engineering service request database 24. This database also transmits an e-mail reminder that a 901S form is awaiting the approval of a particular person if approval has not been acted upon within a specified time, such as five days. At the end of the approval chain, an accounting department project coordinator assigns a unique project number to the document. The approved service request document is a key document that is stored in engineering service request database 24, and also stored in project database 18 for ready access. The 901S form is a primary reference for all persons involved in this project, at least until cost estimates are complete. Engineering service request database 24 and its automated approval system are designed to meet quality system requirements for traceability of the request, assignment of responsibilities, collection of customer requirements and control of documents, etc. Document creation and approval are automated as much as possible to speed the initiation and awareness of a project.

When the service request is approved at 68, the fully approved request is automatically linked to a manager, who assigns a project leader at 70. The approved 901S form is transmitted by e-mail to the assigned project leader, who then defines the initial project team at 72 by transmitting the approved 901S form to other members of the team. As each succeeding participant is assigned to the project by the origination of an e-mail from a superior, engineering service request database 24 (FIG. 1) automatically enables that participant to access the project information. The project leader creates the new project document in the project database 18, and provides each team member with a date by which the initial engineering estimates must be completed. The team members employ the 901S form as a reference for the project scope requirement, and perform initial engineering work at 40 as required to arrive at preliminary cost estimates. Links to initial engineering drawings, calculations and correspondence are placed in project database 18 under the direction of the project leader. Initial engineering work 40 may include, for example, initial furnace design work, initial calculation of electrical power requirements, and initial estimates of changes required for existing mechanisms that feed glass to or receive glass from the furnace. Based upon this initial engineering work, the various team members generate initial cost estimates at 42, which are assembled by the project leader for approval at 44. The project may be approved, cancelled or modified as required at stage 44.

If the project is approved by management, the project leader directs the engineering disciplines to begin detailed engineering by gathering customer requirements at 74 and converting them at 46 into specifications for equipment and construction drawings. This process often requires visits by the engineering disciplines to the plant to complete specification questionnaires, establish detailed inventories of equipment that can be reused, and generally document the requirements of the plant. Questionnaires, correspondence, specifications, drawings and contractor bid package links are placed in the project documentation section of project database 18. Using the detailed engineering specifications, the engineering disciplines prepare final cost estimates of the equipment and materials required for the project. Using these final cost estimates, an equipment expenditure request is generated at 48, which may be designated as a form 901E in the present example. This 901E form is then automatically sent through the preset management approval chain by successive e-mails with a link to the 901 E document stored in the expenditure request database 26. The e-mails inform each approver in sequence that approval is required, and generate an automatic reminder if approval is not forthcoming within a specified time. Approvals are logged automatically on the 901 E document in the expenditure request database 26, and the project leader and plant manager are notified by e-mail when the final approval has been obtained.

The project leader sends an e-mail with a link to the approved 901E form to all project engineers, who then initiate at 52 the ordering of necessary equipment and services. The engineers and purchasing agents employ purchasing database 30 and associated purchase request and order forms to place the purchase orders. As noted above, in the special case of ordering an individual section glassware forming machine, which is not involved in the glass furnace example under discussion, the order would be placed through machine ordering database 28 rather than purchasing database 30. Changes in equipment and system components or design brought about by customer request, product availability or engineering necessity are approved on appropriate forms, and the documents are stored in project database 18. If approvals are required, project database 18 automatically generates the necessary e-mails, and the approvals are entered into the database.

After project materials and equipment have been delivered to the plant, contractors and service personnel construct and install the equipment according to the engineering drawings and specifications generated at 46 and stored in engineering request database 24. Each participating engineer maintains a log of field changes, installation difficulties, part failures or other quality issues, and places this information on the appropriate form as a trip report entered into database 22. Field changes are also entered into as-built drawings and filed with the project data. After the equipment has been installed, engineering personnel assist in start-up of the equipment and training of operator and maintenance personnel. Records of trained personnel and other information associated with commissioning of the equipment are stored in trip report database 22. Changes that require engineering of a system component are documented in engineering change database 20. The project may be evaluated at 58 (FIG. 1) by a customer satisfaction meeting or survey, and/or by meetings among project team members, contractor representatives and customer representatives. Members of the critique meeting can access project data and reports quickly through project database 18 and links to other databases. Customer satisfaction surveys are quality records stored in project database 18.

The process of the present invention provides a number of advantages. The process is implemented on a networked computer system, such as an intra company network, for ready access by all authorized personnel. The process provides automated work flow for review and approval by automatically sending e-mails to reviewers when review is required, and providing a link in the e-mail that takes the reviewer directly to the document to be reviewed. Reviews and approvals are automatically recorded with the document. The process preferably automatically notifies reviewers periodically to check the validity of a document after a specified time has elapsed, and reminds them until the review process has been completed. The process preferably maintains a clear separation between current documents and documents under revision by locating them in clearly labeled separate sections of a database, and preferably by placing a watermark on the documents under revision that indicates, for example, that the document is a “draft document.” The process preferably maintains a readily reviewable history of changes and the dates on which the changes became effective as part of each document. The process makes documents readily accessible wherever they may be needed by being available on a company intranet. The process keeps documents legible and identifiable by maintaining them in electronic form, which can readily be printed if required. The process preferably prevents unintended use of obsolete documents by placing any that must be retained in a separate clearly identified section of the associated database and placing a watermark on the document such as “obsolete document.” From a quality control standpoint, the process in accordance with the preferred embodiment of the invention identifies initial customer requirements, the names of key personnel involved in the project, and key dates for project-related activities. The process provides traceability through a unique project number, visibility for the project throughout its life by appearing in the appropriate status section of a database (e.g., awaiting approval, open, closed, archived), provides an organized repository for all correspondence relating to the project among participants, and provides a record of all changes requested, reasons, approvals, and implementation methods and dates.

1. A process for systematizing, monitoring and auditing a project for production of a product or service, which includes:
(a) providing a project description as an interconnection of stages to produce a product or service,
(b) providing custom databases for storage of and access to documents associated with each stage of said description provided in said step (a),
(c) at each stage of production of the product or service provided in said step (a), entering documents into an appropriate database provided in said step (b), so that, during or upon completion of the product, performance at each stage of the project description can be audited by access to the documents in the custom database or databases associated with that stage.

2. The process set forth in claim 1 wherein said custom databases include a project database that includes links to other databases and to key documents entered into the other databases.

3. The process set forth in claim 1 wherein at least some of the documents entered in said step (c) are on forms premade so that entry of the document into the appropriate database automatically cross links the document to other databases specified on the form.

4. The process set forth in claim 3 wherein said forms include approval request forms that, when entered into the appropriate database, automatically send the form to persons whose approval is required.

5. The process set forth in claim 4 wherein said approval request form is automatically sent to persons in a sequence of required approvals.

6. The process set forth in claim 1 including the step of: (d) providing a quality system auditor with access to said databases for auditing documents associated with each of said stages.

7. A method of auditing quality of a project process, which includes the steps of:
(a) establishing in a computer network a series of process elements that collectively define a project,
(b) establishing in said network a series of individual databases for electronically storing documents,
(c) associating each said process element with at least one of said databases,
(d) as the project proceeds, entering all documents associated with each said process element into a database associated with that element, and
(e) providing a quality control auditor with access to said databases for auditing documents associated with each of said process elements.
